(19) United States
(12) Patent Application Publication
(10) Pub. No.: US 2013/0236865 A1
(43) Pub. Date: Sep. 12, 2013

(54) SYSTEMS AND METHOD FOR MODIFYING HUMAN BEHAVIOR USING AN AUDIO RECORDING DURING SLEEP

(71) Applicant: Deborah Hamui, Aventura, FL (US)

(72) Inventor: Deborah Hamui, Aventura, FL (US)

(73) Assignee: SLEEP 'N SYNC, LLC, Aventura, FL (US)

(21) Appl. No.: 13/634,580

(22) PCT Filed: Mar. 16, 2011
(86) PCT No.: PCT/US11/28616

§ 371 Date: Sep. 13, 2012

Related U.S. Application Data
(60) Provisional application No. 61/314,191, filed on Mar. 16, 2010.

(51) Int. Cl. G09B 19/00

(52) U.S. Cl. CPC G09B 19/00
USPC 434/236

(57) ABSTRACT

The invention provides a method or system for modifying behavior in a human subject using an audio recording during sleep. The audio recording includes positive suggestions for achieving a desired result recorded over background music. Binaural beats are incorporated into the background music. The positive suggestions are directed to the subconscious mind and address a specific goal the human subject wishes to achieve or a specific problem that the human subject wishes to overcome. The audio is pre-recorded and designed to be listened to by the human subject on a daily basis for a pre-determined period of time. The method includes a Guide that provides important information, recommendations, and key language terms for the human subject and/or caregiver for best results. It also provides Evaluation Forms to measure and track the progress and results throughout the process.

### CROSS REFERENCE TO RELATED APPLICATIONS

This application claims the benefit of priority to U.S. Provisional Patent Application No. 61/314,191, filed on Mar. 16, 2010, the content of which is herein incorporated by reference in its entirety.

### FIELD OF THE INVENTION

The invention generally relates to behavior modification and problem solving, particularly to systems methods for behavior modification through synchronization of the subconscious mind with the conscious mind, and most particularly to systems and methods for modifying human behavior using an audio recording during sleep, wherein the audio recording includes positive suggestions for helping the human achieve a desired functional outcome recorded over background music with binaural beats.

### BACKGROUND

People are always searching for ways to utilize the power of the mind to change behavior.

Hypnotherapy is a technique that uses the hypnotic state, which enables changes in perception and memory, and produces a major increase in response to suggestion, and therefore a better access to the subject's subconscious mind. Hypnotherapy uses guided relaxation, intense concentration, and focused attention to achieve a heightened state of awareness. The subject's attention is so focused in this state that whatever is going on around the subject is temporarily blocked out or ignored. In this naturally-occurring state, a subject may focus his/her attention on specific thoughts or tasks.

There are three phases involved in hypnotherapy: (1) a relaxation phase; (2) a suggestion phase; and (3) a post-hypnotic suggestion phase. The relaxation phase is a guided way for the subject to reach the appropriate receptive state for the therapist's suggestions. Once the person has reached that relaxation level (phase 1), the therapist gives suggestions specifically designed to help the patient with a certain problem (phase 2). The suggestions are integrated into the person's subconscious mind so that they guide him/her to take specific actions and/or attitudes that will help him/her to progress towards desired objectives.

Positive suggestions are known to be the appropriate means to be taken by the subconscious mind of the person, and are effective in the objective of synchronizing the subconscious mind with the conscious mind, helping the person to achieve his/her desired goals. For the hypnosis to be successful, three elements must be present: (1) self motivation, (2) believable suggestions, and (3) repetition.

Hypnotherapy is not a dangerous procedure. It is not mind controlling or brainwashing. A therapist cannot make a person do something embarrassing or something the person doesn't want to do. For example, the therapist can suggest to the subject that is afraid of flying, while he/she is in a relaxed-receptive state, that any time the subject is going to travel by air, his/her inner voice will guide him/her towards the desired mental state and positive feelings that will allow him/her to behave in the desired way; in this case, travel with minor stress and anxiety. The post-hypnotic suggestion would be in this case, the desired mental state and positive feelings that are triggered by an internal feeling of anxiety and stress about flying. Therefore the post-hypnotic suggestions recall the desired mental state and positive feelings and the subject experiences the recalled mental state and positive feelings disrupting the usual anxiety and stress about flying.

Usually, hypnotherapy sessions are conducted by an experienced hypnotherapist who is actually present with the patient (subject). In a formal hypnotherapy session for helping to solve a specific problem, the therapist will develop a post-hypnotic suggestion that may be unique for the patient. For example, if the patient's objective is to lose weight, the therapist might suggest that the patient think of the pink dress she wants to wear for a wedding before she tries to eat something unhealthy. Other suggestions might work better for other patients. For example, the therapist could suggest visualizing the fat particles running through the (patient's) blood stream once he has eaten French fries.

Similar suggestions are also used as aids in other treatments (non-hypnotic) through the use of visualizations to achieve a desired outcome. For example, when a patient is ill with a bacterial infection and he/she is getting the appropriate medical treatment, it is helpful to suggest the patient visualize a battle in his/her body in which he/she is the strong army that is fighting to eliminate all the bad bacteria that is causing the illness, and that he/she is victorious and the infection is abated.

In current conventional methods of hypnotherapy, to place and maintain suggestions and post-hypnotic suggestions, the therapist helps to create the relaxed state of heightened awareness, places the suggestions and post-hypnotic suggestions, and then terminates the hypnosis. Afterwards, a recognized situation or cue elicits the post-hypnotic suggestion from the patient's subconscious and the suggested behavior or feeling results. The session might be audio-recorded, and that audio might be taken by the patient to be listened to on a regular basis at a place where he/she can relax and be uninterrupted for the duration of the audio.

Additionally, audio recordings may be used in hypnotherapy outside of what is discussed in regular sessions with a hypnotherapist. The current use of formal post-hypnotic suggestion has been used by mental health professionals who directly or indirectly with the use of pre-recorded audios, aid the patient by creating the state of heightened suggestibility and then place the suggestion. The suggestion and imaging use can also be used in non-therapeutic environments like motivational sessions for workers, salespeople, and the like, and can be delivered by a leader or by a pre-recorded audio or video.

Another type of hypnotherapy, “hypnopedia” is also in current use. In hypnopedia, the subject attempts to learn new information which is presented during sleep via audio recordings (Guides, Andy, article describing his (Guides) book “A Guide to Learning While You Sleep” obtained from the website of Learn Out Loud). Additionally, similar methods have also been used to enhance memory (Belluck, Pam, “Sounds During Sleep Aid Memory, Study Finds” The New York Times, online, Nov. 20, 2009; Rudoy, J. D. et al. “Strengthening individual memories by reactivating them during sleep” Science 326 (5956): 1079, 2009).

With the continued study of the effects of positive suggestion administered during sleep, new methods can be developed that will utilize the power of the mind to change behavior, which in turn may decrease or eliminate the need for traditional diagnoses and medications.

### SUMMARY OF THE INVENTION

The invention addresses challenges faced by humans, particularly children. These challenges are addressed in a positive manner through hypno-therapeutic principles. The system and method help create brain networks while the child is sleeping. This allows the child to overcome problems, to have the ability to function effectively, and to achieve goals and other desired results, for example, dealing with bullying, dealing with emotions, dealing with frustration and anger, flexibility, anxiety, and organizing time. By making the right brain connections and training their subconscious mind to be on the same page as their goals, the goals are naturally attained.

Generally, the invention provides systems and methods, which when carried out, help a human subject modify his or her behavior to reach his/her desired goals and/or improve his/her functional performance, solving the problem being addressed. More specifically, the invention provides a system and method for modifying behavior in a human subject using an audio recording during sleep, wherein the audio recording includes positive suggestions for helping the human achieve a desired functional outcome recorded over background music. The subject is usually a human person. The audio is pre-recorded and designed to be listened to by the human subject on a daily basis for a period of time, particularly, but not limited to, six weeks. Additionally, the background music used in the audio includes binaural beats. Use of the binaural beats is optional, but may be beneficial. The positive suggestions are directed to the subconscious mind and address a specific result and/or goal the human subject wishes to achieve. The method is accomplished through synchronization of the subconscious mind with the conscious mind during sleep.

A “subject” or “person” is any human being in need of behavior modification or having a problem to be solved. The human subject can be any person, but is preferably, albeit not limited to, a child fourteen years of age or under.

A “caregiver” is most often a parent of the child subject. However, the term is not limited to a parent, a caregiver could be a teacher, a babysitter, a relative, or any concerned adult.

One embodiment of the method includes the steps of: (1) providing positive suggestions to the subject while the subject is sleeping, the positive suggestions for achieving the desired result; (2) suggesting conscious actions to the subject while the subject is sleeping, the conscious actions for achieving the desired result when the subject is awake; and (3) informing the subject that the suggestions and conscious actions will be recalled when the subject is awake directing behavior for achievement of the desired result.

The positive suggestions may further include suggestions for reinforcing the self confidence and self esteem of the subject.

The behavior to be modified includes any behavior that the subject desires to change and may include an attitude, fear, sensory problem, or any issue that prevents the subject from achieving the desired result.

The suggestions and conscious actions recalled are generated automatically when an event, an object, an activity, a situation, a need, a thought, or a behavior related to the desired result is presented to the subject when awake.

Another embodiment of the method involves problem solving via synchronization of the subconscious mind with the conscious mind and includes the steps of (1) providing positive suggestions to the subject while the subject is sleeping, the positive suggestions including strategies for solving the problem; (2) integrating the positive suggestions into the subconscious mind of the subject; and (3) informing the subject when the subject is sleeping of a way to retrieve the positive suggestions from the subconscious mind to the conscious mind when awake, thereby synchronizing the subconscious mind with the conscious mind to solve the problem.

The positive suggestions can also include suggestions of conscious actions for solving the problem that the subject may recall and implement when awake.

The system and method differ from hypnotherapy in that the present invention relies precisely on using sleep as the time to access the subconscious mind of the subject/person. In hypnosis, the hypnotherapist has to take the person into a hypnotic trance (alpha, theta, delta brainwaves), next provide the suggestions and post suggestions, and finally the hypnotherapist has to take the person out of the hypnotic trance. The described invention does not require the person/patient to enter into the hypnotic trance, and thus does not require that the person/patient be taken out of the trance.

One embodiment of the invention is a problem-solving system that can be used by a caregiver to help a subject to solve a problem, the system including the steps of: (1) identifying a problem to be solved; (2) selecting a program including an audio recording addressing the problem from a menu of programs; (3) reviewing instructions accompanying the selected program; (4) introducing the program to the subject; (5) playing the audio recording to the subject on a daily basis while the subject is sleeping for a pre-determined period of time, particularly, but not limited to, six weeks; and (6) monitoring progress of the subject toward overcoming the problem by filling out an evaluation form accompanying the program. The evaluation may take place on a weekly basis during the time period the audio recording is being used.

The system/method includes a Guide that provides important information, recommendations, and key language terms for the human subject and/or caregiver for best results. It also provides Evaluation Forms to measure and track the progress and results throughout the process.

The system/methods are effective problem-solving tools and may be applied in a number of programs for effectively treating a wide range of behavioral, attitude, sensory, and/or fear problems/issues that might be interfering with a person's positive goal achievement and performance in different areas of the person's life.

The problems/issues addressed (by the audio recordings) can be organized into genres, for example, but not limited to, behavioral, sensory, organization, fears, social skills, values, academic skills, and sports. Within each genre of problems, there are specific issues treated independently in each one of the pre-recorded audios and adjunct information. Additionally, pre-recorded audios can be custom made according to the needs of the person/patient.

A system useful for carrying out the methods of the invention is also provided. The system includes (1) an audio of positive instructions recorded over music; (2) a guide including instructions for using the program; (3) a musical soundtrack; and (4) evaluation forms for monitoring progress of behavior modification in the subject.

The audio recording is also referred to as a “non-transitory media storage device.”

It is therefore an objective of the invention to provide methods, systems, and programs for behavioral modification and problem solving.

It is an objective of the invention to provide a method for treating behavioral, attitude, fear, sensory, and/or other problems/issues in a human subject, particularly a child, in order to help the subject achieve his/her desired goals or desired result, solve a problem, and/or improve his/her functional performance.

It is another objective of the invention to provide a method for providing positive suggestions to a human subject.

It is another objective of the invention to provide a method for providing positive suggestions to a human subject for reinforcing the self confidence and self esteem of the subject.

It is an objection of the invention to provide a method for providing suggestions of conscious actions that a subject may take to achieve a desired result and/or to solve a problem.

It is another objective of the invention to incorporate the positive suggestions and post-suggestions to the subconscious mind of the human subject through repetition.

It is another objective of the invention to synchronize the subconscious mind with the conscious mind.

It is another objective of the invention to provide a problem solving system.

It is yet another objective of the invention to provide relevant information about the specific issue and/or problem to be targeted.

It is still another objective of the invention to provide an alternative whether or not to use advantages of binaural beats with the audio recording.

It is another objective of the invention to provide the positive suggestions recorded over a relaxing background music, which is developed using binaural beats technology to an appropriate frequency for sleep and receptiveness.

It is yet another objective of the invention to provide a kit including items for carrying out the described methods, the items including, but not limited to, an audio recording having positive suggestions recorded over background music; headphones or an acoustic pillow; written instructions for using the audio recording the and headphones/acoustic pillow; and written evaluation forms for tracking progress of the human subject as the method is being carried out. Additionally, the kit may be provided without headphones or an acoustic pillow.

The above objections are merely exemplary of the invention. Other objectives and advantages of this invention will become apparent from the following description taken in conjunction with the accompanying drawings, wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

A more complete understanding of the present invention may be obtained by references to the accompanying drawings when considered in conjunction with the subsequent detailed description. The embodiments illustrated in the drawings are intended only to exemplify the invention and should not be construed as limiting the invention to the illustrated embodiments.

FIG. 1 is a flow chart illustrating the step-by-step progression through the problem-solving system of the invention.

FIG. 2 is an example of an evaluation form provided with the Flexibility I program. This form is for the utilization of the parent or caregiver.

FIG. 3 shows B's Evaluation Form.

FIG. 4 is an example of an evaluation form provided with the Flexibility II program. This form is for the utilization of the parent or caregiver.

### DETAILED DESCRIPTION OF THE INVENTION

For the purpose of promoting an understanding of the principles of the invention, reference will now be made to embodiments illustrated herein and specific language will be used to describe the same. It will nevertheless be understood that no limitation of the scope of the invention is thereby intended. Any alterations and further modification in the described methods, techniques, kits, media storage devices, and/or any further application of the principles of the invention as described herein, are contemplated as would normally occur to one skilled in the art to which the invention relates.

Behavior modification is notoriously difficult. The present invention provides a method and system for modifying human behaviors, attitudes, fears, and/or sensory problems through the use of audio recordings which should be played to the person while sleeping, on a daily basis, during a period of time, particularly, albeit not limited to, a relatively short period of time, about six weeks. Modification of behaviors may be applied to solve problems and/or to reach a desired result. The length of each audio recording is relatively short, preferably less than thirty minutes. The audio may be played once to the person while sleeping, or alternatively, may be continuously repeated throughout the period of sleep. If the person wants the benefits of the binaural beats, a listening period of about two hours or less is recommended, although not limited as such.

More specifically, the present invention involves (i) providing a pre-recorded audio with specific positive suggestions and recommended conscious actions designed to address a specific problem; (ii) considering that in sleep the subconscious mind is in a high level of receptivity to suggestion, the audio recording must be played to the person on a daily basis while the person is sleeping; (iii) the audio should be played to the person on a daily basis, so that the repetition helps the mind to integrate the positive suggestions and actions; (iv) reinforcing the desired behaviors and implementing of functional outcomes by involving the person in the selection of goals, reviewing the desired outcomes, analyzing and/or discussing the goals and alternative behaviors, reactions, etc. and/or the development and reading of written stories that relate to the implementation of appropriate functional performance and skills; and (v) an additional optional feature of the audio recordings is the binaural beats technology used in the background music. The binaural beats help the mind synchronize the frequency of the neurons through the use of different frequencies on each ear. The person's head is placed between two speakers such that the binaural beats are generated by the brain. This frequency synchronization is known to facilitate the occurrence of brain cell connections.

Certain theories and physiological states described below influence the design of the audio recordings used in the described methods and systems, including, but not limited to, positive suggestion; brain frequency states; binaural beats; sleep; repetition; sensory-based problems; and sensory integration.

### Positive Suggestions

Positive suggestions are a known way to access the subconscious mind of a person. The subconscious mind has varying degrees of alertness, but is aware all the time. Positive suggestions given to the subconscious mind are accepted and integrated as long as they are in accordance to the person's goals and objectives.

Positive suggestions are considered positive statements that are positive affirmations that help build a positive mind. A positive mind empowers the person to do the things that can make him/her successful in achieving desired goals. This is because positive thinking can replace negative thinking increasing the probability of success.

It is known that with a negative statement such as “don't think of the color red”, the person listening to such a statement will indeed think of the color red. With positive suggestions one can effectively lead the person's mind to the desired thoughts and images, and the person's subconscious mind will absorb the desired positive statements.

If a person has negative thoughts like “I can't do it”, the person is programming him/herself for failure, so it is likely that the person will actually confirm this belief when the failure happens, that is once he/she tries to do what he/she is thinking that he/she cannot do, and the result is that he/she could not do it.

### Brain Frequency States

Brain waves are generated by the neurons in a person's brain. Neurons, or brain cells, communicate with each other through electrical and chemical changes. The electrical changes can be seen in the form of brainwaves in an electroencephalogram (EEG). They (the waves) are measured in cycles per second (Hertz: Hz) and are known as the frequency of brainwave activity.

The human brain produces detectable signals or waves which vary in strength and frequency over time and from one part of the brain to another at any given time.

Different frequencies are associated with different moods and changing abilities. The slower the brain activity, the lower the frequency or Hz of the activity. In the 1930's-40's researchers identified different frequencies, and they are generally classified within the following four types of brainwave states: Beta; Alpha; Theta; and Delta. Beta (12-40 Hz) is a conscious state in which the mind is awake, alert, sharp, and focused. The person having beta brainwaves is actively thinking Alpha (6-12 Hz) is also a conscious state, but identified with the mental experience where images are not identified. It has come to be associated with feelings of pleasure, pleasantness, tranquility, serenity, and relaxation. It can also imply a relaxed concentration. It is also a place of light sleep and several dream states. Theta (4-7 Hz) is traditionally labeled “unconscious” in Western medicine. Theta has come to be associated with day dreaming, sleep, cognition of problem solving, future planning, remembering, switching thoughts, and creativity. Delta (1-4 Hz) is a state predominantly associated with no-dreaming sleep or deep sleep.

### Binaural Beats

Binaural beats work by sending two slightly different tones to each ear. The frequency difference between the tones is created inside the head as a “binaural beat.” With this technology one can take the mind into a relaxed and more receptive state, and then regulate brainwave activity in the desired frequencies. For example, if a pure tone of 100 Hz is presented to the right ear, and a pure tone of 109 Hz is simultaneously presented to the left ear, an amplitude-modulated standing wave of 9 Hz (the difference between 109 and 100 Hz) is produced by the brain, and perceived as a third beat known as the binaural beat.

When a person listens to audios created to cause binaural beats through separation of sound in both ears, after some time the brain cells get synchronized by the frequency of the binaural beats allowing easier connections between the brain cells.

Audios with embedded binaural beats, mixed with music or background sounds, are being used for relaxation, meditation, stress reduction, pain management, improved sleep quality, decrease in sleep requirements, super learning, enhanced creativity and intuition, and various other things.

### Sleep

Sleep follows a regular wave cycle; the EEG pattern changes in a predictable way several times during a period of sleep. There are two basic forms of sleep; (1) rapid eye movement (REM) sleep and non-rapid eye movement (NREM) sleep. It is known that infants spend about half their sleeping time in REM, while adults spend only about 20% of their sleep time in REM. Most dreaming occurs in REM sleep.

Sleep already provides the receptive mind state for suggestions, since it is known that the brainwave states are usually between alpha and theta, both highly receptive states for suggestions. The subconscious mind is always awake, and it is more receptive when the person is in a relaxed phase, as when he/she is asleep.

### Repetition

Repetition wires the brain. It is repetition which allows a person's brain to establish the necessary connections or synapses between the brain cells. Learning occurs where neurons meet. Without these connections, the brain cells are useless. It is known that what wires a person's brain is repeated experience, and without it, key synapses don't form. And if such connections, once formed, are used too seldom to be strengthened and reinforced, the brain eventually eliminates them. Therefore, repetition of the desired messages in the suggestions is a key element for the effectiveness of the message incorporation into the subconscious mind of the person.

### Sensory-Based Problems/Sensory Integration

Sensory integration is the ability to organize sensory information for use. In order to effectively interact and function within our environment each person must take in information from the environment, integrate this information within his/her nervous system and produce an appropriate response. The process of taking in information from the environment entails processing information from the senses. The senses include vision, hearing and touch, as well as the deep senses of the vestibular (gravity receptors) and proprioception (muscle and joint receptors) receptors. The human body takes in information passively from the environment but also actively from the body itself as it moves and interacts with the environment. The brain must be able to take in sensory input from the environment and the body, and then it must organize this information in order for the person to respond appropriately to a particular situation.

When a person has a sensory problem, or a sensory integrative problem the body does not receive or interpret the sensory information from the environment the same way as others. This can occur within one sensory system or multiple, and results in complex interrelated problems. When individuals have deficits of processing and integrating sensory inputs, deficits in planning and producing behaviors occur and interfere with conceptual learning, motor learning, adaptability, emotional and behavioral regulation, and functional performance and interaction.

Sensory-based problems and/or sensory integrative difficulties often display functional problems in one or more of the following areas: i) Sensory Modulation Disorder characterized by sensory over-responsivity, sensory under-responsivity, or sensory seeking; ii) Sensory Discrimination Disorders; and Sensory-Based Motor Disorders including postural disorder and syspraxias.

Traditional intervention for Sensory Integrative Disorder involves clinic based one-on-one intervention. Intervention requires the provision of enhanced sensory intake, provided within the context of meaningful activity and the planning and organizing of an adaptive behavior. This is often referred to as the “bottom-up approach” as it works from the body through the nervous system. The “top-down approach” involves cognitively teaching the person strategies and coping skills. Top-down strategies may include: i) developing social stories or sensory stories that teach the person appropriate alternative behaviors. These stories are read to or by the person daily, especially before the event. ii) utilizing relaxation strategies or deep breathing, especially when encountering or about to an encounter stressful situations. iii) teaching the person self awareness and environmental modifications that will help with emotional and behavioral regulation.

Hypnosis principles have never been reportedly used on this population. The goal of using hypnosis principles on individuals experiencing sensory integrative problems and sensory-based difficulties is to use positive suggestions to empower the person to engage in activities that will help organize and integrate the sensory inputs and the nervous system. Through the use of cognitive strategies and hypnosis principles the goal is to synchronize the subconscious mind with the conscious mind in order to engage in effective coping strategies and activities to improve function. The goal is also to aid in the integration of sensory information on a subconscious level in order to improve the person's coping and functional skills.

### Example I

### General Method and System

The following is a description of the actions, information, and contents of the program (including the pre-recorded audio) that a person interested in changing a specific behavior, attitude, sensory problem, or fear would follow (to carry out the method of the invention).

The person, or caregiver, has access to a menu of programs and/or audio recordings. The audio recordings are categorized by genre of issue/problem addressed and by targeted age range. A non-limiting example of seven genres divided into individual sub-genres is shown in Tables 1A-B.

TABLE 1A

| Social Skills | Sports | Organization |
|---|---|---|
| Making Friends | Tennis | Schedule |
| Rules of Friendship | Football | Work |
| Conversation Rules | Soccer | Thoughts |
| Playing Rules | Basketball | Back-Pack/Desk |
| Are you Joking? | Volleyball | |
| Fitting In | Baseball | |
| Peer Pressure | | |
| Bully | | |
| Bullied | | |

TABLE 1B

| Academic Skills | Fears/Sensory | Behavior/Sensory | Values/Emotions |
|---|---|---|---|
| Focus/Attention | Being Alone | Nail Biting | Self-Esteem |
| No More Shut Downs | Darkness | Biting Others | Doing What's |
| | | | Right |
| Sustained Work Effort | Thunder/Fireworks | Skin Picking | Respect |
| Memory/Recall | Balloons | Sound Discrimination | Good Manners |
| Independent Work | Clowns | Bed Wetting | Cheating |
| Follow Instructions | Dogs | Toilet Training | Telling Lies |
| Test Stress | Heights | Sleep in Your Own | Know it All? |
| Management | | Bed | |
| Test Taking Strategies | Crowds | Stress | Frustration |
| Homework Strategies | New Places | Frustration | Angry Explosions |
| Learning to Read | Noises | Just Do It! | Anxiety |
| Read and Visualize | Public Speaking | Motivation | |
| Time Concepts | Movement | Flexibility | |
| Math Concepts | Being Touched | Bullying | |
| Participate in Class | Fear of Change | Sensory Issues | |
| Impulse Control | Improve | Keep on Task | |
| | Processing | | |
| Improve Processing | Anxiety | | |
| Organization | | | |

Each program/audio is designed to address a specific behavior, attitude, fear, sensory problem, or other issue that can interfere with the person's desired goal achievement and/or functional performance. Each one of the pre-recorded audios in the menu is accompanied with appropriate information about the problem, the most common characteristics of that problem, the way it is addressed in the audio, and the way this method/system works. With this information, the person or caregiver can choose the appropriate program/audio that can help the person to overcome that particular problem and/or achieve a desired result. Additionally, a pre-recorded audio can be custom made according to the needs of the person/patient.

Once the appropriate program/audio is available to the person (or caregiver), with instructions of use, it should be played on a daily basis for a pre-determined amount of time, i.e. about six weeks, to the person while he/she is sleeping. The positive suggestions can be heard and understood directly by listening since they are not hidden in music.

If the person or caregiver wishes to get the benefit from the binaural beat technology in the background music, he/she will need to place his/her head in between two speakers so that each ear receives the sound designed to be heard through it. This can be achieved with headphones, a special acoustic pillow with speakers placed exactly on the sides of the person's head so that each ear receives directly the sound of each speaker.

A Caregiver Instructions Guide is provided with the selected program/audio recording. This Guide contains important information for the caregiver and the subject using the program, including, but not limited to: information about the problem to be addressed (in the recording); the concepts addressed (in the recording); recommendations in terms of support of the subject during the time the subject is using the program; what to expect when using the recording; the key terms the subject must know to understand the messages recorded (in the audio recording); instructions for using evaluation forms; and suggested further reading and references.

An evaluation form is provided with the program in which the targeted goals are specifically written so that they can be easily monitored and measured on a regular (i.e. weekly) basis for the duration of the program (usually about six weeks), starting on day zero, using a scale of 1 through 5, in which 1 is always (100% of the time), 2 is frequently (75% of the time), 3 is occasionally (50% of the time), 4 is seldom (25% of the time), and 5 is never (0% of the time). This form provides the person with a tool to record and measure progress, which can be voluntarily returned as feedback.

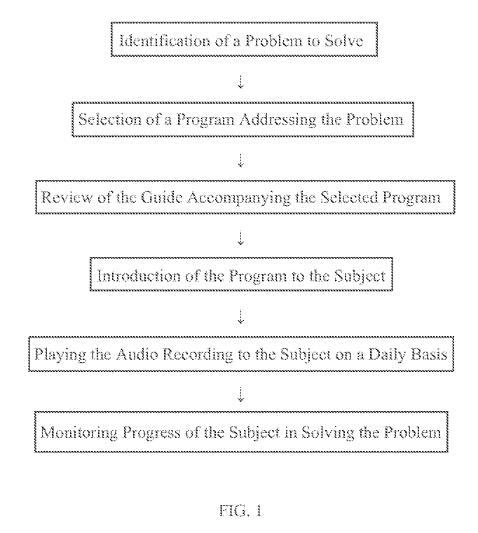

The invention can be undertaken as a problem-solving system including steps for: identifying a problem to be solved; selecting a program, including an audio recording, addressing the problem from a menu of programs; reviewing instructions accompanying the selected program; introducing the program to the subject; playing the audio recording to the subject on a daily basis while the subject is sleeping for a pre-determined period of time; and monitoring progress of the subject toward overcoming the problem by filling out an evaluation form accompanying the program. FIG. 1 illustrates the steps of this problem-solving system.

### Example II

### Specific Embodiment, Bullying

In order to further explain the present invention, there will be described hereinafter a specific exemplary embodiment, i.e. a program for dealing with the problem of bullying. It should be appreciated that the present invention is not limited to this exemplary embodiment and includes other applications and uses.

This exemplary embodiment begins with a child being bullied, particularly in school. The caregiver acknowledges that the child is having a specific problem being bullied that is interfering with the child's happiness, self esteem, and self confidence.

The caregiver accesses the Applicant (Sleep'n Sync) website that describes the method and the science behind the method that explains the reasons as to why the method works. In the same website, the caregiver clicks on the menu of products, and reads the targeted problems in each one of the programs/audios. After a deeper examination of the information describing each audio's targeted problem, together with the information provided to help the caregiver select the right audio for the child, the appropriate audio should be selected, in this case, “Bullying: Teaching Your Child How to Handle Situations Involving Bullies”. The present invention also contemplates that the website can provide a series or questions and/or prompts, the responses to which will result in an automatic recommendation and/or selection of the appropriate audio(s).

The audio is easily downloaded (in MP3 format or other available audio formats) so that it can be played to the child as he/she sleeps, as specified in the method. The evaluation form accompanies the audio in the Caregiver Instructions Guide, so that the caregiver is able to monitor and quantify the progress of the child in each targeted issue. This form can also be filled in and sent back through an email address provided at the website of Sleep'n Sync to provide feedback, in a voluntary way.

The audio is played to the child every night, when he/she is sleeping, during approximately six weeks. The audio can be played once when he/she is sleeping, or alternatively, the audio can be repeated throughout the period of sleep (if using the binaural beats feature, a period of listening of about two hours or less is recommended). The evaluation form is filled out before beginning the program, and thereafter on a weekly basis, and progress is registered. The child is informed, prior to starting the program, about the audio that is to be played to him/her every night while he/she is sleeping, and what goals are expected to be achieved with the help of this method/system.

Suggestions describing actions, positive feelings, and attitudes, are contained in the audio. These positive suggestions are consistent with the objective of making the child not vulnerable to bullying. They (the suggestions) hold the curative value for the child's condition of vulnerability and empower the child to take the suggested actions that will ensure his/her safety together with actions and attitudes that will render him/her less vulnerable to bullies, obviously empowering the child's self confidence and self esteem. These suggestions are repeated several times and in several different ways to assist the child with integrating the suggestions into his/her subconscious mind.

The audio starts with a soothing background music, then pre-recorded messages (over the music) such as: “you will listen to my voice . . . my voice will tell you positive things that will stay in your mind . . . that will help you feel good about yourself . . . you will have positive feelings . . . positive thoughts . . . and positive behaviors.”

Positive suggestions are then provided as to what the child's inner voice in his/her mind will say, like “I am a confident person . . . I am confident now . . . I believe in myself . . . I am a good person . . . a confident person . . . I show I am confident . . . showing my confidence helps to stop others from picking on me . . . I have a confident attitude . . . a confident body language . . . I show my confidence with my body . . . in my posture . . . in how my body moves . . . and in how I interact with others . . . I am confident . . . I believe in myself . . . I like who I am . . . and my body projects this confidence.”

Furthermore, suggestions such as “from now on I will respect myself as I respect others . . . I know I am very important . . . I deserve respect . . . I will stay safe” are spoken in the audio.

Additional recommendations are provided in the accompanying Caregiver Instructions Guide to be done at the same time that the program is being implemented. In this case, the recommendations could be that the caregiver should talk to the child about bullying, what it is, how it affects the victim, and what actions the child should take and why. In this case the actions to be taken by the child can include acting with confidence, being assertive, avoiding fights, leaving the situation, and immediately seeking help from a responsible adult when the child is in danger, hanging out with others so that he/she is safer (safety in numbers) among other actions. The recommendations would also include actions that should be taken by the caregiver like talking to the child's teachers in the school, if the bullying is taking place there, to inform him/her about the problem that the child is facing, and to ask for help with that problem.

The recommendation of telling the child about the actions that can help him/her to eliminate the problem, together with the audio recording played every night during the child's sleep, help to synchronize in an effective way the subconscious mind with the conscious mind of the child. This synchronization helps the child to effectively take the appropriate actions and have the right attitude that will help him/her deal with and eliminate the bullying problem being faced, and gain confidence and a higher self esteem.

The caregiver uses the evaluation form provided to register the starting point on the written targeted areas and the (weekly) progress of the child. Then, as an optional action, the caregiver uploads the results through the website such that appropriate feedback can be provided.

The binaural beats incorporated into the music provide an additional element that firmly establishes the suggestions in the child's subconscious mind. If the caregiver and/or child wishes to take advantage of the binaural beat technology headphones or a pillow with acoustic speakers should be used when playing the audio recording.

### Example III A-B

### Flexibility: Helping Your Child Cope with Change

The described invention includes three flexibility programs:

Flexibility I: Helping Your Child Cope with Change and be Open to Help—assists the child develop self confidence needed to become more flexible, receptive to change, and more accepting of help from others. This program focuses on building the child's confidence and giving him or her strategies to deal with the inherent anxiety associated with change.
Flexibility II: Helping Your Child Cope with Change and Transitions—recommended for the child who has difficulty coping with change, accepting help from others, and additionally has difficulty transitioning from one activity to the next. This program builds on the concepts addressed in Flexibility I, helping the child to let go and become less threatened by changes in daily activities, transitioning smoothly from activity to activity.
Flexibility III: Helping Your Child Cope with Change, Transitions, and Leaving an Unfinished or Preferred Activity—recommended for the child who has difficulty coping with change, accepting help from others, has difficulty transitioning from one activity to the next, and also finds leaving an enjoyable activity (preferred task) or an unfinished task very difficult. This program builds on the concepts addressed in Flexibility I and II, helping the child develop the confidence and flexibility needed to cope with change, transition, and move from preferred or unfinished tasks or activities.

Examples III A and B are written to directly address the parent or caregiver. This indicates that the text is part of the Caregivers Instructions Guide.

### Example III A

### Flexibility I

The program Flexibility I was used in the following case study. The following description includes excerpts from the Caregivers Instruction Guide (for Flexibility I).

Flexibility can be defined as “responsive to change”, “capable of variation or modification”, and “adaptable and able to change or adjust to other's wishes, new conditions, demands, or circumstances.”

Every day children encounter situations that require them to adapt to change. When one thinks of it, life is full of changes on all levels. No two days are ever exactly alike. Even when one tries to duplicate a day exactly like the day before, there are still changes. There are differences between the activities scheduled and the demands places on a child on a Saturday or Sunday compared to a weekday. Change is all around us and embedded in our day. There are changes that are not planned. For example, one can run out of the child's favorite cereal, there is a substitute teacher, mom or dad has to go away on a business trip, or the weather changes and one couldn't go on a special outing. Changes, no matter how small or large, require a child to adapt, change, and be flexible. This openness, adaptability, and flexibility are also key components to learning.

Many children (and adults) find comfort in routine and repetition. Predictability and familiarity helps them relax and operate on a stress free, automatic level. When things are scheduled and repeated a child may relax, knowing exactly what will happen and what is expected of him or her. All children want to succeed and flourish. They need and want to master their environment and be successful. For some children, routine and repetition, allows them to feel confident and successful.

Adjusting to change and being adaptable requires a child to be secure and self confident. When a child feels insecure, questions their ability to successfully complete an activity or be able to change how the activity was performed, they will resist change. Change or impending change may elicit feelings of fear and anxiety which makes the child resist change even more.

Feeling insecure is often a normal part of growing up and developing. Some children just have more difficulty adjusting to change and feeling confident than other children. The claimed programs and methods can help such children.

Children may feel insecure, fearful, and anxious with changes for any number of reasons that stem from a variety of underlying problems. They may have difficulty figuring out how to do a new activity (motor planning) or to move their body (motor awareness) to complete an activity in a coordinated way. These problems along with other sensory related concerns can contribute to low self confidence, high anxiety, and difficulty adjusting to change. The claimed programs and methods work for addressing the child's underlying problems. The program works on empowering a child to overcome fears, try new activities, and be open and receptive to learning.

When a child has difficulty coping with change it is often because they find comfort and security in things that are the same (routine and repetition). This need for “sameness” may originate due to sensory processing difficulties or behavioral needs. This need for “sameness” may make them appear inflexible, resistive, and/or unwilling to accept help or learn from others. The claimed program is designed to help the child's subconscious mind reconnect with their confident conscious self. Through internalizing this confident self concept, looking at change and new activities as a positive experience and having strategies to use to overcome fear and anxieties, a child should be more comfortable, adaptable, open, receptive, and flexible with everyday experiences.

The claimed program is designed to be used in combination with the implementation of recommendations by the parent or caregiver through the program. The program helps the child's subconscious mind feel more secure and self confident in order to permit him/her to let go of rigidity and the need for control. These skills in combination with the child's natural motivation to achieve these results, the conscious understanding of such skills (achieved by following the recommendations), and implementation of support strategies by the parent/caregiver provides the perfect combination that can help the child feel more comfortable and secure with change and be a happier child.

### Instructions for Flexibility I

Helping Your Child Cope with Change: How to Approach it Support and encouragement can help your child through difficult times. Remember that your child's inflexibility may be triggered by a fear of failure. Be patient and help your child relax and feel confident.

Praise your child for any sign of flexibility or coping with change, no matter how small it may be. Small steps lead up to big changes. Let your child know the good things that you observe. Tell your child how proud you are of him or her. When complimenting your child, be sure to be very specific so your child understands exactly what you liked. For example, instead of saying “good boy” say “I really liked how you waited your turn” or “I really liked that you asked for help.”

Do not lecture your child. Lecturing often makes a child feel worse. Point out the positives while trying to avoid the negatives.

### Help Your Child Overcome Anxiety and Fear of Failure

Many children have a need to control activities due to fear of failure. While children may not consciously think “I am afraid I will fail”, their actions demonstrate their fear. They will avoid tasks that they were not successful at within the past while repeating things that they did well.

### Encourage, Support, and Praise:

Encourage your child to try new tasks and activities. Start with tasks that are similar to, but slightly different from things that your child is comfortable doing. Support your child both verbally and physically, as needed. Verbally support and encourage your child. Statements like “I know you can do it”, “You are really good at this. I believe you can do it” will help spur your child on. Physically support and help your child. While the goal is to help your child be successful, there is a secondary goal that is almost more important. In order for confidence to build, your child needs to be able to figure out how to do the new task by him or herself. This requires a delicate juggling act from the parent or caregiver. You need to follow the child's lead. Be there if the child needs help and step back if the child is doing ok. Sometimes it helps to let the child know “I will help you if you need it.” The goal of supporting your child is to guarantee that the child is successful, does not get hurt, and can figure out how to do the new or different task or activity. Praise and compliment your child every step of the way.

### Fear and Anxiety:

If your child becomes anxious or fearful at any point, don't push. Encourage them to take a deep breath, relax, then support and encourage them. Just do it! Many children can do things automatically without thinking. However, when they do think about it, think about previous failures, think about the task, they may be immobilized by fear. If something triggers a fear reaction or anxiety, for some children, doing it fast or getting it over with, relieves this anxiety. Then they can look back at it with a sigh of relief and marvel at their successes. In this program, a child will learn the phrase “just do it.” When your child stops in the middle of an activity or starts to think too much about what is involved in the task, encourage him or her and verbally let them know “you can do it” go ahead “just do it.”

### Help Your Child Handle Unexpected Events and Changes Through Preparation

Unexpected change can set off even the most adaptable, flexible child. For a child with difficulty being flexible and coping with change this will be his or her biggest challenge. There are things you can do to make any change of plan easier for your child.

Preparation: Children become less anxious and nervous if they know what to expect. Prepare them for the change. Let them know where, when, and what. When will it happen, where will it occur, and what to expect. The more details you can provide the better. Many children, especially if they are stressed, have difficulty understanding what you say to them verbally. Support what you tell them with visuals. Use calendars marked with the specific day, visually count the days, use a timer to visually depict time, write out a story about the change and include exactly what to expect. Frequently review with your child what will be happening and what to expect. With this program your child will be working on building self confidence and belief in his or her ability to cope with change, be flexible, relax, and be more adaptable. The parent or caregivers support is critical to the child's success in accomplishing these goals.

The concepts addressed in the audio recording for the Flexibility I program are listed below in Table 2.

CONCEPTS ADDRESSED IN THE FLEXIBILITY I
AUDIO RECORDING

Positive self concept, feeling good about yourself, staying calm
Keeping your mind and body focused, relaxed, and flexible
Adjusting to change
Trying new activities
Letting go of fear and anxiety
Looking forward to change and learning
Dealing with unexpected changes
Being open to learning (relax, patience with self, patience with
others, confidence)
Staying focused and organized on tasks
Following through and initiation of tasks “just do it”
Being open to change and suggestions

### Key Terms Used in the Flexibility I Audio Recording

As the program is language based, it is important for both caregiver and child to be on the same page in the meaning of key terms used throughout the audio recording. The caregiver should review these key terms with the child before initiating the playing of the audio recording.

In Flexibility I these key terms are:
Accomplish: to achieve or complete successfully; to bring to its goal or conclusion; carry out, perform
Adjust: adopt or become used to a new situation
Anxious: experiencing worry, unease or nervousness about something with an uncertain outcome
Confidence: self assurance, belief in your ability to succeed
Distracted: (or without distractions) unable to concentrate because one's mind is preoccupied; having the attention diverted
Experiment: to try new activities or to try doing something a little bit different
Flexible: accepting something a little different from what you originally wanted or being open to new ideas or different ways to do things
Follow Through: continuing an activity or task to its conclusion
Intelligent: bright or smart, using your mind to figure things out
Interruptions: (interruptions should be avoided) anything that stops or breaks the continuous progress of an activity or task
Regain: get back to, recover
Social Stories: stories developed by Carol Grey that give accurate information regarding situations they encounter or will encounter
Situations: sets of circumstances; state of affairs
Time Timer: a clock that visually shows time go by; the timer has a section of red indicating an allotted time, the red section disappears as time runs out
Wander: to take one direction or another without conscious intent or control; to have different unrelated thoughts

### Using the Flexibility I Program

Have a conversation with your child about using the program. Make sure to disclose what you both want to achieve through carrying out the program, and the program's requirements: listening to the audio recording on a daily basis while sleeping during six weeks and monitoring progress on a weekly basis using the evaluation forms.

It is very important to be aware that the program needs your (the parent/caregiver) participation, not only to play the audio recording every night to your child when he or she is asleep, but by supporting your child throughout the process.

### Parent or Caregiver's Support

What your child might do and your support:

Try new activities or things that are different. Notice any changes in flexibility, cooperation, or ability to try new activities and let him or her know how proud you are. Compliment your child on the good things you see. Be specific in your compliments.

Stop an activity when frustrated or anxious and take some deep breaths. Remember to support, encourage, and praise your child. Provide support and encouragement when your child is frustrated. Give your child enough space to be able to calm down, re-organize and be able to move back to the activity at hand. Provide verbal and physical assistance, if needed. Help your child stay safe and successful.

Your child might ask for help or be open to your help. You might have to ask your child if they would like your help. Honor their wishes. If they say no, let them know you will be close by in case help is needed. If they ask for your help, be there for them. Don't do it for them. Show them how to do it and help them learn to master it. If your child gets frustrated, let them know you believe in them and that taking a deep breath might help.

Your child might talk to himself or herself when he or she is trying to figure out how to do something or getting frustrated. Your child may tell himself or herself things like “you can do it” or “just do it.” Let him or her work it out and be there in case he or she needs your support. Praise him or her when he or she figures it out or is able to complete the task or activity. If your child appears stuck encourage him or her to go faster and not think about it. Encourage your child to “just do it.”

Your child might ask you a lot of questions especially when there is an unexpected event or a change of plans. Preparation is always the first step. Prepare your child before a change of plans or an unexpected event occurs. Answer their questions to help them stay calm and not get anxious. Take it a step further and work with them to be able to better understand what will be happening. Use visuals to help them really see it and understand what to expect. Use calendars, time timers, pictures, social stories, or any other aid to help them understand what will happen and what to expect, where the change will occur, and when to expect it. Remember to help your child to be prepared. Support and praise your child every step of the way.

Your child may be more willing to try new activities. He or she will be working on developing a positive attitude and approach to tasks. If sensory or physical abilities are holding him or her back, you might consult an occupational therapist experienced in sensory integration.

### Evaluation Forms

The program includes evaluation forms for the parent or caregiver and the child. These forms are tools to measure your child's progress through the time the program is being implemented and to evaluate the final results.

The evaluation forms are easy to use. First record the date your child starts the program and the starting point in each concept listed. Then, on a weekly basis, through the duration of the program, record the progress observed and/or experienced by the child. Your child's progress and results are very important, especially for your child.

The caregiver or parent is encouraged to share the results at the Sleep'n Sync website. The information provided will be used for product development purposes. All personal information will be safely kept and will not be shared.

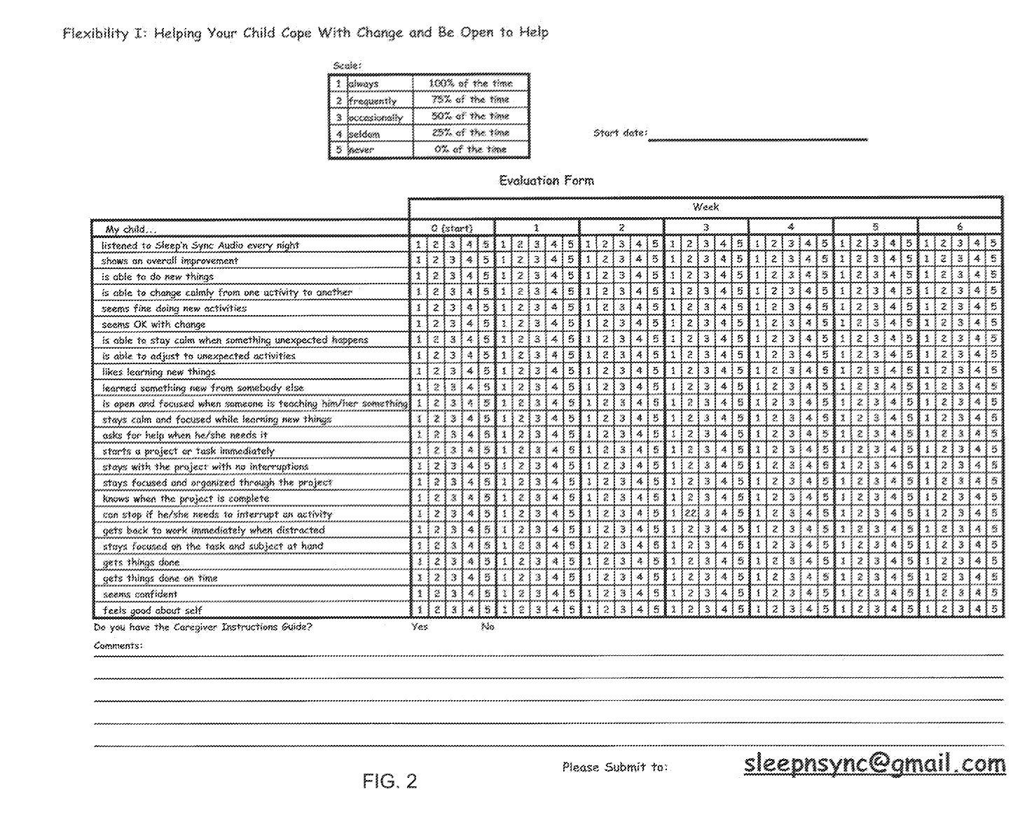

An evaluation form provided with the Flexibility I program is exemplified in FIG. 2. This form is for the parent or caregiver. An identical evaluation form is also provided for the use of the child.

### Bonus Musical Track

The Flexibility I program includes a bonus musical track. Like all of the program's audio recordings, this bonus musical track includes binaural beats. It is an engineered soundtrack designed to synchronize your child's brainwaves, leading to optimal brain organization. This benefit is obtained through the use of speakers that separate the sounds of different frequencies, as with headphones or a two-speaker acoustic pillow. The use of this technology is optional. The program may be undertaken with or without the use of binaural beats. However, having your child listen to this bonus soundtrack before or after the Flexibility I audio soundtrack is played can help your child to better absorb the suggestions (on the audio recording) while sleeping. Never play any of the recordings (audio recording or bonus musical track) while driving as the binaural beats are relaxing and the effect can make you drowsy.

### Example III B

### Flexibility II

The program for Flexibility II is similar to that of Flexibility I, but further includes coping with transitions. The following description includes excerpts from the Caregivers Instruction Guide for Flexibility II than differs from Flexibility I.

Transitions are a challenge for a child struggling to cope with change. A “transition” can be considered to be any situation that requires change, such as a change of location, activity, or support personnel. Transitions can be minor, such as changing activities within a classroom, or major, such as moving from preschool to grade school. Any transition requires a child to stop one activity, move from one location to another and begin something new. In a regular school day, children may be asked to transition between 15 to 20 times (Fischer et al. Teaching behaviors, academic learning time, and student achievement: An overview. In C. Denham & A. Liberman (Editors), A Time to Learn (pages 7-32), 1980, Washington, D.C.: National Institute of Educators). These transitions not only require a child to stop one activity and move on to another, but often require a child to change to another room or location. The process of moving from one location to another often involves high activity and noise levels. For a child struggling to cope with change, a child who needs structure and routine to feel safe and secure, transitions become very stressful.

There are a few common problems encountered with transitions. Transitions require more than just coping with change. The child must understand their schedule, the warning signs of the transitions, finish their activity in time for the change, know where they are to move to, understand the process of the transition, and control their stress and anxiety during a transition. With the help of a caregiver, this program is designed to help the child's subconscious mind reconnect with their confident self. Through internalizing this confident self concept, looking at change and new activities as a positive experience and having strategies to use to not only overcome fears and anxieties but to increase their awareness and knowledge of what is expected, a child should be more comfortable, adaptable, open, receptive, and flexible with everyday experiences.

### Instructions for Flexibility II

Transition strategies are techniques used to support children during change or disruptions to activities, settings, or routines. Many of these techniques can be used before a transition occurs to help the child anticipate the change and during the transition to help the child move to the next location smoothly. These techniques are designed to help the child concretely understand the schedule, what is expected, where they need to go, and what they need to do. These strategies also allow the child to understand when a change or disruption to the schedule may occur.

Help your child understand their schedule and the activities that are planned for the day, week, and for some children, even the month. Find the right calendar or schedule for your child. Make sure it is visible and easily available to your child. You may choose to have it with your child at all times, such as on his or her notebook. Sometimes having a duplicate schedule posted on your refrigerator at home is helpful.

Review activities planned on a regular basis. Teach your child how to use the schedule, especially for fun activities planned. Have your child show you what day it is. Then have your child show the day when the fun activity is planned. Have your child count the days until the activity. Do this everyday to reinforce the schedule and assure that your child internalizes how to use the schedule.

Regularly review scheduled activities. As with special fun activities, help your child understand their regular weekly activities and schedule. Once your child understands the entire schedule, some children like to have their activities for the day reviewed; others need to know just what is coming next. Remember, if there is a change in any routine scheduled activity you must review this change in advance.

Social stories are great ways to help a child internalize their schedule for the week or even month. Social stories are stories developed to review a sequence of events. In this case you can develop a story that resembles your child's schedule. It should be read several times a day (by either the caregiver or child).

Prepare your child for the transition. Give your child advance warning that the activity is about to end and a new one is going to begin.

Give your child enough time to finish what they are working on. Some activities wrap up quickly while others need more time. Help your child bring closure to the task at hand.

Let your child know exactly how much time they have before the transition or change. Several strategies work: use a time timer (visual depiction of time); give a verbal warning and continue to count down (for example, 5 more minutes, 4 more minutes, 3 more minutes, 2 more minutes (you need to have your supplies put away), and one more minute (everything should be put away)); and review the transition strategy before your child has to actually move. Review exactly where they will be going and what you expect.

Some children will move to the next activity without difficulty, others seem to get lost along the way. If your child is one that has difficulty moving to the next activity, the following hints may help:

Make sure your child knows exactly where to go and what to do (can he or she tell you the plan?).

Give your child something to do that will get them directly to the place you want them. If it is your car, ask them to carry your keys to the car. How about carrying your books to the next class and putting them on the desk for you. Or you could give your child a picture of where they should be going and have them posit it on their desk when they get there.

Give your child something to do that is fun, while he or she is moving. How about snapping their fingers all the way, or singing a specific song. Singing the same song for a transition is a good strategy for transition. Pick one song to transition out the door to school and a different song to go to bed at night.

Songs can also be used that relate to the actual activity you will be doing. They can bring closure to the last activity. Teach the sequence for the new activities and teach following directions from simple to complex sequences (Pica. R. Teachable Transitions, Beltsville, Md., Gryphon House).

The concepts addressed in the audio recording for the Flexibility II program are listed below in Table 3.

CONCEPTS ADDRESSED IN THE FLEXIBILITY II PROGRAM

Positive self concept, feeling good about yourself, staying calm
Keeping your mind and body focused, relaxed, and flexible
Trying new activities
Letting go of fear and anxiety
Looking forward to change and learning
Transitioning easily from one activity to the next, dealing with change
Dealing with unexpected changes
Being open to help and learning
Follow through and initiation of tasks, moving from one task to another
Being open to change and suggestions

In Flexibility II additional key terms are:
Pattern: regular sequence of activites
Schedule: a series of things or activities to be done or of events to occur at or during a particular time or period
Unexpected: sudden, not planned

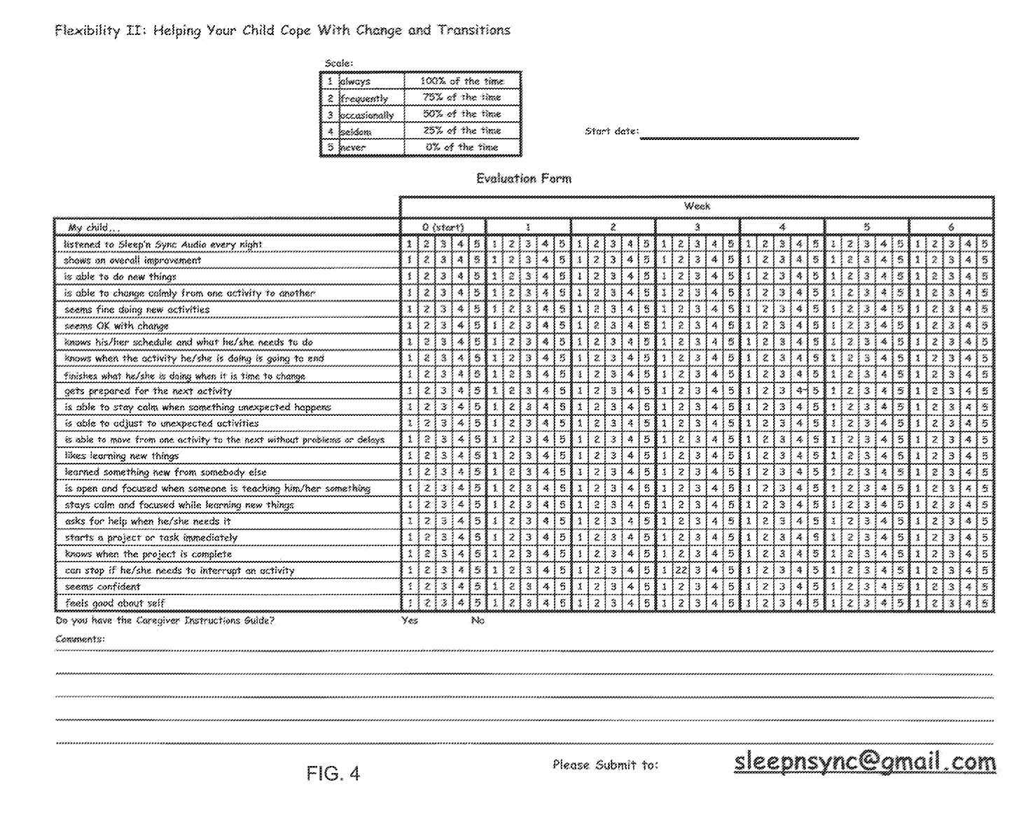

An evaluation form similar to that provided with the Flexibility I program is provided with the Flexibility II. This form is exemplified in FIG. 4. This form is for the parent or caregiver. An identical evaluation form is also provided for the use of the child.

### Example IV

### Case Study, Flexibility I: Helping Your Child Cope with Change and be Open to Help

To better explain and demonstrate the effectiveness of the described methods/systems/programs, an actual case study in which the program Flexibility I: Helping Your Child Cope With Change and Be Open to Help was used.

### Preliminary Data:

### Name: B

Initial date on program: Feb. 4, 2010
Age: 5 years
B is a five year female. She is an outgoing, highly verbal, pleasant, and happy child in a regular kindergarten.
Her parents voiced the following concerns:
Controlling Behavior—She refuses to let anyone teach her. She changes the rules so she is in control of every situation. She is verbally aggressive and hurtful to others when she does not get her way. She can not accept not being a winner in a game. She wants to control everyone's role during play.
Distractibility—She cannot stay focused on an activity. She gets up and walks away in the middle of meals, activities, conversations, and school activities. Her thoughts interrupt her ability to listen. She will interrupt conversations because she is thinking of something else.
Rigid and inflexible—She is unable to complete an activity until she feels it is completed. She cannot take a joke.
Fear and anxiety—She has fear and anxiety with new tasks or activities that require her to move or have motor planning She has difficulty trying to figure out how to do something. This may be as simple as jumping over a two-inch block or jumping off of a curb. She will try and try but be unable to do it. She panics going down escalators and stairs.
Pre-test—A Sensory Profile (Winnie Dunn, Ph.D., OTR, FAOTA, The Psychological Corporation, 1999) was administered prior to starting the program. B's overall scores were 147 which placed her in the middle category (probable differences). She scored an 8 for movement sensitivity (definite differences), an 18 on auditory filtering (definite difference on auditory sensitivity), a 26 for under-responsive sensory seeing (probable difference) and an 18 for auditory/visual sensitivity (probable difference).

B received occupational therapy once a week to address some of her sensory integrative difficulties. The occupational therapist was concerned that while she had made progress in occupational therapy, she exhibited little functional carry over. She was unable to change the behaviors that were stopping her from functioning or problem solving. For example, while she was physically able to jump over a two-inch block, she could not get herself to do it. Instead she would stand in front of the block, move her feet in an up-and-down motion, and say over and over again “I can't do it.”

Prior to starting the Flexibility I program, B's mother completed a short Sensory Profile and the Evaluation Form. She played the audio recording every night for six weeks while B was sleeping. Each week her mother completed the Evaluation Form. At the end of the six week period, B's mother completed a follow-up Sensory Profile and tabulated the weekly evaluations.

### Results:

Her parents reported seeing a dramatic improvement in B. B is problem-solving better and is quick to correct or apologize when something she says is hurtful. She is now able to self-correct her behavior instead of impulsively exploding. She wants to discuss problems and ask for help about what she should do. Physically, she is pushing herself to overcome her fear. She is asking for her parents to be with her as she works on climbing and walking on curbs, jumping off curbs, and trying new and different motor tasks. She is much more tolerant of others, especially her sister. She is less demanding and rigid. She is calmer and more enjoyable to be around.

Post-Test—A second Sensory Profile (Winnie Dunn, Ph.D., OTR, FAOTA, The Psychological Corporation, 1999) was administered immediately after B completed six weeks of the program. B's overall scores improved to 173 from 147 (17.7% improvement) which now placed her functioning within normal limits. Scores for movement sensitivities improved from 8 to 13 (62.5% improvement) now placing her in the normal to typical range. Scores on auditory filtering improved from 18 to 24 (33.3% improvement) now placing her in the normal to typical range. Scores for under-responsive sensory seeing improved from 18 to 32 (77.8% improvement) which now placed her functioning within normal limits. Scores for auditory/visual sensitivity improved from 18 to 21 (16.7% improvement) which now placed her functioning within normal limits.

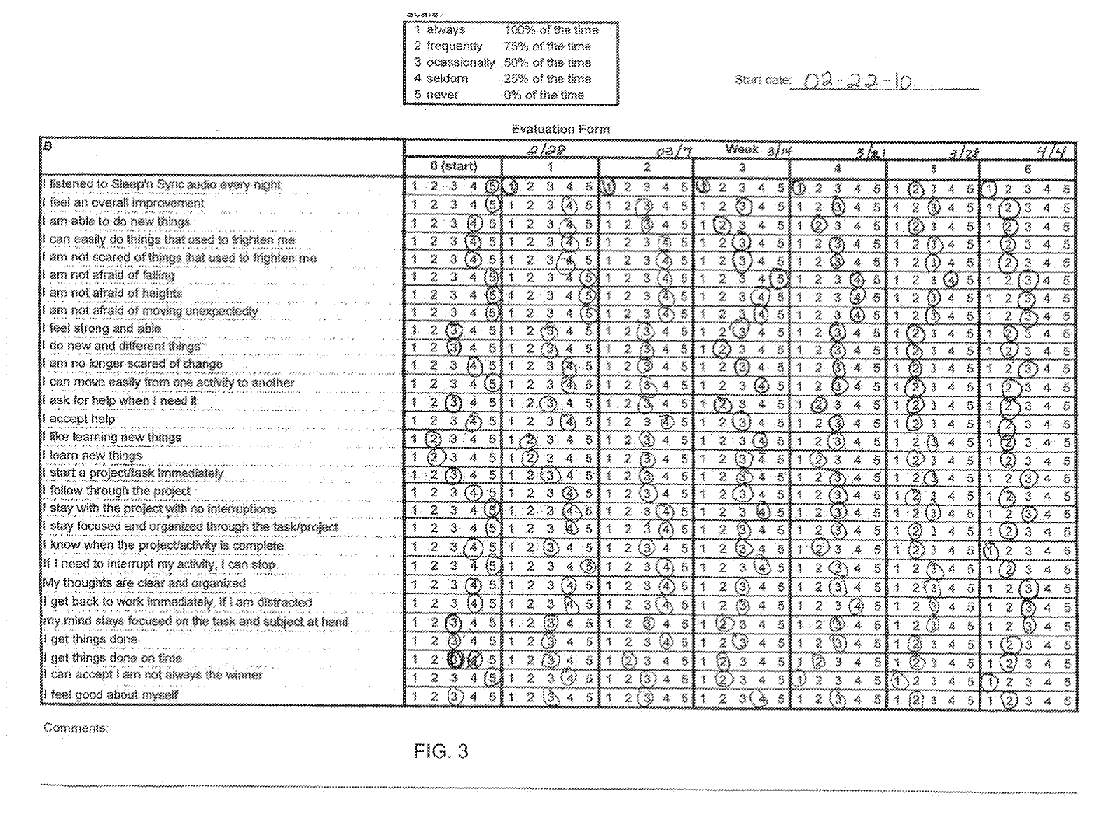

Progress can be seen on the parents' evaluation form including an average improvement of 1.72 for each category. Some areas showed greater gains than others such as “she can easily move from one activity to the next” improved 3 levels starting at a grade of 5 (never) and improving to a 2 (frequently). “I stay organized throughout the task” also improved from a 5 (never) to a 2 (frequently). B's evaluation form is shown in FIG. 3.

Having described an exemplary embodiment of the present invention, attention now will be turned to the other aspects of the present invention. As described previously, the present invention targets a specific problem with the use of positive suggestions and post-suggestions pre-recorded in an audio with soothing background music. The repetition of suggestions and post-suggestions given by playing the audio to the person while sleeping on a daily basis strongly reinforces the suggestions in the person's subconscious.

The systems/techniques/methods described herein can be used to treat behavioral, attitude, fear, sensory, and/or other issues in human subjects, particularly, albeit not limited to, in children. The system and method of the present invention may be applied in a number of programs for effectively treating a wide range of behavioral, attitude, sensory, and/or fear problems that might be interfering with a person's positive goal achievement and performance in different areas of the person's life.

Although the various embodiments of the present invention are described in the context of a fully functional computer system via the internet, those skilled in the art will appreciate that embodiments are capable of being distributed as a program product via CD or DVD, e.g. CD, CD ROM, or other form of recordable media.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not intended to be limited to the specific form or arrangement herein described and shown. It will be apparent to those skilled in the art that various changes may be made without departing from the scope of the invention and the invention is not to be considered limited to what is shown and described in the specification. One skilled in the art will readily appreciate that the present invention is well adapted to carry out the objectives and obtain the ends and advantages mentioned, as well as those inherent therein. The methods, techniques, systems, programs, and kits described herein are presently representative of the preferred embodiments, are intended to be exemplary and are not intended as limitations on the scope. Changes therein and other uses will occur to those skilled in the art which are encompassed within the spirit of the invention. Although the invention has been described in connection with specific, preferred embodiments, it should be understood that the invention as ultimately claimed should not be unduly limited to such specific embodiments. Indeed various modifications of the described modes for carrying out the invention which are obvious to those skilled in the art are intended to be within the scope of the invention.

1. A method for modifying behavior in a subject in need of behavior modification wherein modification of behavior allows the subject to achieve a desired result, the method comprising:
a) providing positive suggestions to the subject while the subject is sleeping, the positive suggestions for achieving the desired result;
b) suggesting conscious actions to the subject while the subject is sleeping, the conscious actions for achieving the desired result while the subject is awake; and
c) informing the subject that the suggestions and conscious actions will be recalled when the subject is awake directing behavior for achievement of the desired result.

2. The method according to claim 1, wherein the behavior to be modified is an attitude, fear, sensory problem, or any issue that prevents the subject from achieving the desired result.

3. The method according to claim 1, wherein the suggestions and conscious actions recalled are generated automatically when an event, an object, an activity, a situation, a need, a thought, or a behavior related to the desired result is presented to the subject when awake.

4-6. (canceled)

7. The method according to claim 1, wherein steps a)-c) are carried out using audio instructions provided to the subject by an audio output from an audio.

8. The method according to claim 7, wherein the audio instructions are recorded over music.

9. The method according to claim 8, wherein the audio instructions are provided to the subject on a daily basis for a pre-determined amount of time.

10. The method according to claim 9, wherein the pre-determined amount of time is about six weeks.

11. The method according to claim 8, wherein the music includes incorporated binaural beats.

12. The method according to claim 1, wherein the method is for a subject fourteen years of age or under.

13. A problem-solving system for a subject in need thereof, the system comprising:
a) means for identifying a problem to be solved;
b) means for selecting a program addressing the problem from a menu of programs, the program including an audio recording;
c) instructions accompanying the selected program;
d) means for introducing the program to the subject;
e) means for playing the audio recording to the subject on a daily basis while the subject is sleeping; and
f) means for monitoring progress of the subject toward overcoming the problem by filling out an evaluation form accompanying the program.

14. The system according to claim 13, wherein the system is for a subject fourteen years of age or under.

15. The system according to claim 13, wherein the means for playing is configured for daily use for a pre-determined period of time of about six weeks.

16. The system according to claim 13, wherein the means for introducing the program includes terms used in the audio recording to be reviewed with the subject.

17. The system according to claim 13, wherein means for monitoring progress of the subject is configured for use on a weekly basis.

18-21. (canceled)

22. A system for modifying behavior in a subject, the system comprising:
a non-transitory media storage device including audio of positive instructions recorded over music;
a guide including instructions for using the system;
a non-transitory media storage device including a musical soundtrack; and
evaluation forms for monitoring progress of behavior modification in the subject.

23. The system according to claim 22, wherein the positive instructions include suggestions for reinforcing self confidence and self esteem; suggestions for achieving a desired result; and suggestions of conscious actions for achieving the desired result.

24. (canceled)

25. The system according to claim 23, wherein the behavior to be modified is at least one of an attitude, fear, sensory problem, or any issue that prevents the subject from achieving the desired result.

26. The system according to claim 22, wherein the music includes incorporated binaural beats.

27-28. (canceled)

29. The method according to claim 1, wherein achieving the desired result includes solving a problem by synchronizing a subconscious mind of the subject with a conscious mind of the subject and b) further includes integrating the positive suggestions and conscious actions into the subconscious mind of the subject and c) further includes informing the subject when the subject is sleeping of a way to retrieve the positive suggestions and conscious actions from the subconscious mind to the conscious mind when awake, thereby synchronizing the subconscious mind with the conscious mind to solve the problem and achieve the desired result.

30. A non-transitory media storage device encoding a program for carrying out the method according to claim 13.
